(19) United States
(12) Patent Application Publication
(10) Pub. No.: US 2026/0316533 A1
(43) Pub. Date: Oct. 15, 2026

(54) EMERGENCY EXIT ASSEMBLY FOR VEHICLES AND CONVERSION KIT THEREFOR

(71) Applicant: The Braun Corporation, Winamac, IN (US)

(72) Inventors: Roberto Martin, Winamac, IN (US); Christopher C. Wegner, Winamac, IN (US)

(73) Assignee: The Braun Corporation, Winamac, IN (US)

(21) Appl. No.: 19/643,227

(22) Filed: Apr. 9, 2026

Related U.S. Application Data
(60) Provisional application No. 63/787,416, filed on Apr. 11, 2025.

(51) Int. Cl. B60J 5/04; E05C 3/04

(52) U.S. Cl. CPC B60J 5/0486; B60J 5/0473; E05C 3/045

(57) ABSTRACT

The present disclosure relates to an emergency exit window assembly for vehicles, designed to enhance passenger safety by providing a reliable egress route during emergencies. The assembly comprises a window mounted within a vehicle body aperture, featuring a hinge mechanism to allow pivoting from a closed to an open position. A locking system, including latch hooks and pin brackets, secures the window in place while allowing quick release. Frame members, adhered to the window edges, provide structural support and stability. The assembly is adaptable to various vehicle types, complying with relevant safety standards. The installation process includes removing the OEM window, attaching hinges and frame members, and securing the assembly to the vehicle body. The design ensures a weather-resistant seal and integrates seamlessly with the vehicle's aesthetics, offering a versatile and effective emergency egress solution.

### CROSS REFERENCE TO OTHER APPLICATIONS

This application claims priority to U.S. Provisional Patent Application No. 63/787,416, filed on Apr. 11, 2025, the contents of which are incorporated herein by reference.

### FIELD OF THE DISCLOSURE

The present disclosure relates generally to vehicle safety systems, and more particularly, to an emergency exit assembly for vehicles. The disclosure includes methods for converting a standard vehicle panel into an emergency exit, a modified vehicle incorporating such an assembly, and a kit for retrofitting the assembly onto existing vehicles. The disclosed embodiments are designed to enhance passenger safety by providing a reliable and accessible egress option during emergency situations, conforming to relevant safety regulations.

### BACKGROUND

In recent years, there has been an increasing emphasis on improving vehicle safety features to protect passengers during emergencies. One critical aspect of vehicle safety is the provision of reliable and accessible emergency exits, particularly in situations where conventional exits may be obstructed or inaccessible. Traditional vehicle windows, often made of glass, may shatter under impact, posing additional risks to passengers.

Existing emergency exit solutions for vehicles often utilize glass windows and may not adequately address the need for durability and compliance with modern safety standards. Additionally, many vehicles on the road today lack dedicated emergency egress systems, necessitating a solution that can be retrofitted onto existing vehicles.

The regulations set forth by the Federal Motor Vehicle Safety Standards specify the requirements for bus emergency exits and window retention and release systems under 49 CFR § 571.217. This regulation aims to minimize the likelihood of occupants being ejected from the vehicle and to provide readily accessible means of emergency egress. Additionally, 49 CFR § 571.226 establishes requirements for ejection mitigation systems to reduce the likelihood of occupant ejection through side windows during rollovers or side impact events.

The disclosed embodiments provide an innovative approach to vehicle emergency egress by offering a robust and flexible emergency exit assembly. This assembly leverages the use of polycarbonate materials for improved impact resistance and incorporates a hinge and locking mechanism to facilitate easy operation. Designed to comply with relevant safety regulations, including 49 CFR § 571.217 and 49 CFR § 571.226, these embodiments aim to enhance passenger safety and provide peace of mind during emergency situations.

### SUMMARY OF THE EMBODIMENTS

The disclosed embodiments relate to an emergency exit assembly for vehicles, providing enhanced safety and accessibility during emergency situations. The embodiments include methods for converting a standard vehicle panel into an emergency exit, a modified vehicle incorporating such an assembly, and a kit for retrofitting the assembly onto existing vehicles.

In one aspect, a method is provided for converting a vehicle to include an emergency exit assembly. The method involves decoupling a panel covering an aperture in the vehicle body, coupling at least one hinge between the panel and the body, and coupling at least one locking mechanism between the panel and the body. This configuration allows the panel to pivot from a closed position, where it covers the aperture, to an open position that permits passenger egress. Additional features include the use of frame members that enhance the structural integrity of the panel, the application of seals for weather resistance, and the use of polycarbonate materials for improved shatter resistance.

In another aspect, a modified vehicle is described, comprising a body with an aperture originally covered by a panel. In its modified condition, the vehicle features an emergency exit assembly that includes the panel, at least one hinge, and a locking mechanism. The assembly is designed to allow the panel to pivot open, providing an emergency exit. The vehicle may include features such as backing plates for enhanced hinge and lock stability, and adherence to safety regulations 49 CFR § 571.217 and 49 CFR § 571.226.

Additionally, a kit is disclosed for converting a panel into an emergency exit assembly. The kit comprises components such as hinges and locking mechanisms configured to be coupled between the panel and the vehicle body, allowing for the conversion of existing vehicles to include emergency egress functionality. Notably, the kit omits the panel itself, enabling the reuse of the OEM panel, thereby saving costs and ensuring compatibility with various vehicle models. The kit may also include frame members and seals, providing additional structural support and environmental protection.

The disclosed embodiments utilize polycarbonate materials for the panel, offering shatter resistance and compliance with safety regulations, ensuring that passengers have a reliable means of egress in emergency scenarios. These embodiments provide a robust solution for enhancing vehicle safety, offering versatility and cost-effectiveness in retrofitting existing vehicles.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of an emergency exit window installed on a vehicle in a closed position, as seen from the outside of the vehicle.

FIG. 2 is a perspective view of the emergency exit window installed on the vehicle in the closed position, as seen from the inside of the vehicle.

FIG. 3 is a front view of the emergency exit window installed on the vehicle in the closed position, as seen from the outside of the vehicle.

FIG. 4 is a rear view of the emergency exit window installed on the vehicle in the closed position, as seen from the inside of the vehicle.

FIG. 5 is an exploded view of the emergency exit window, illustrating the various components and their assembly.

FIG. 6 is a cross-sectional view of the emergency exit window along the vertical plane identified in FIG. 4, showing the internal structure and arrangement.

FIG. 7 is a detail view of the area identified in FIG. 6, depicting a cross-sectional view of how the hinge is mounted to a body of the vehicle.

FIG. 8 is a cross-sectional view of the emergency exit window along the horizontal plane identified in FIG. 3, illustrating the horizontal layout of components.

FIG. 9 is a detail view of an area identified in FIG. 8, showing a cross-sectional view of how a frame member is adhered to the window.

FIG. 10 is a perspective view of the emergency exit window installed on the vehicle in the open position, illustrating the pivoting action of the window.

FIG. 11 is a perspective view of one of the backing plates used in the emergency exit window assembly.

FIG. 12 is a rear view of the latch mechanism for the emergency exit window, illustrating its components and operation.

FIG. 13 is a side view of the latch mechanism for the emergency exit window, providing additional perspective on its functionality.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

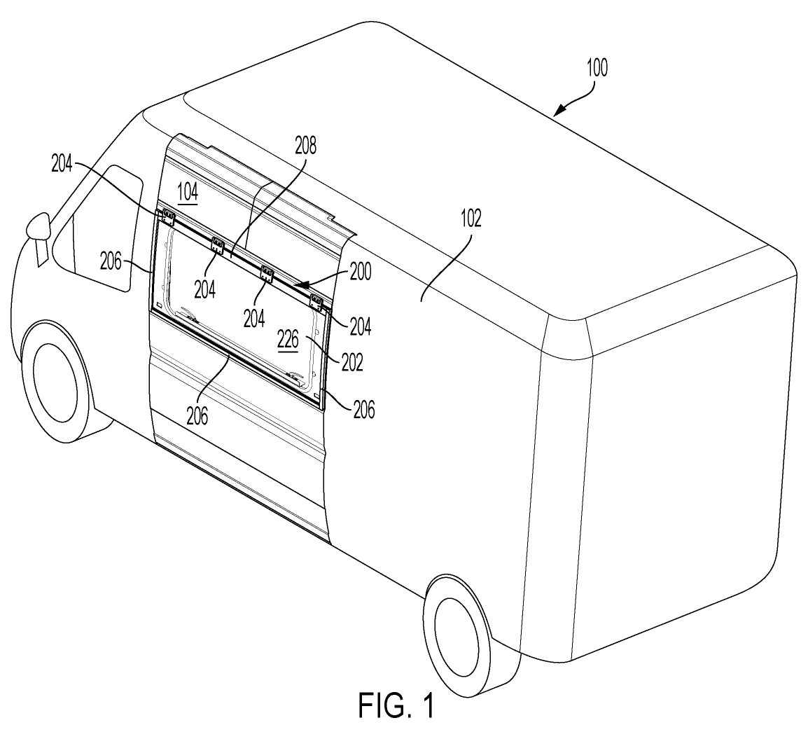

Referring to FIG. 1, an embodiment of an emergency exit window assembly 200 is shown installed on a vehicle 100, as viewed from the outside in a closed position. The emergency exit window assembly 200 is integrated into the vehicle body 102, covering an aperture in the vehicle 100. The window assembly 200 is designed to blend seamlessly with the exterior of the vehicle, maintaining the aesthetic and functional characteristics of the original equipment manufacturer (OEM) design. The outer surface 226 of the window 202 may align with the outer surface 104 of the vehicle body 102, providing a smooth, flush appearance that preserves the vehicle's aerodynamic profile. This configuration ensures that the emergency exit window assembly 200 remains unobtrusive while offering the necessary functionality for emergency egress.

The window 202 may be bordered by four frame members 206, 208, which are positioned at the edges of the window. These frame members provide structural support and help to secure the window 202 within the aperture of the vehicle body 102. Positioned at the top edge of the window 202 may be four hinges 204, which facilitate the upward swinging motion of the window 202 when transitioning from a closed to an open position, allowing for emergency egress. Other numbers of hinges 204, more or less, are contemplated.

While FIG. 1 illustrates the window assembly configured to swing upward, alternative configurations are possible. The hinges 204 may be mounted along the left, right, or bottom edge of the window 202, allowing the window to swing to the left, right, or downward, respectively. These alternative hinge locations provide flexibility in configuring the emergency exit window assembly to suit different vehicle designs and user preferences, ensuring that the assembly can be adapted to a wide range of vehicle types, including but not limited to passenger cars, buses, vans, trucks, and multipurpose passenger vehicles. Its design accommodates the safety and regulatory requirements across these vehicle categories, offering a versatile solution for enhancing passenger safety through reliable and accessible egress options during emergency situations.

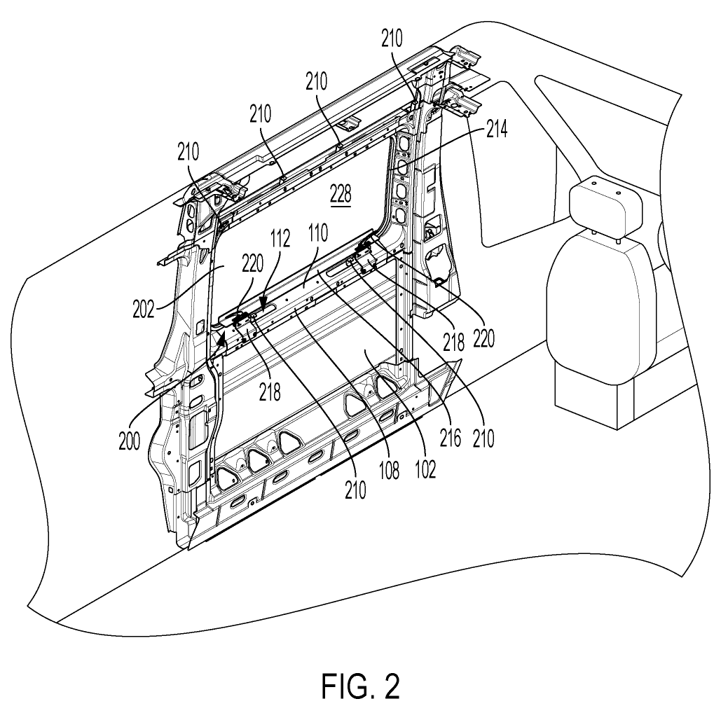

Referring to FIG. 2, the emergency exit window assembly 200 is depicted from the perspective of the vehicle 100 interior, shown in the closed position. This interior view highlights the latch mechanism that secures the window 202 in the closed position, where it is readily accessible in an emergency. Visible in this view is the inner surface 228 of the window 202, which faces the vehicle 100 interior.

The latch mechanism is prominently featured in FIG. 2 and may comprise a latch hook bracket 216 and a latch pin bracket 218. The latch hook bracket 216 may comprise an elongated structure extending nearly the entire width of the window 202. It may be generally L-shaped when viewed in cross-section, comprising a first planar section secured to and generally parallel with the inner surface 228 of the window 202. A second planar section may extend away from and be generally normal to the first planar section, providing additional strength and rigidity to the emergency exit window assembly 200. This configuration not only enhances the structural integrity of the window assembly 200 but also ensures a secure closure when the window 202 is in the closed position.

The two latch hooks 220 may be held by the second planar section of the latch hook bracket 216, disposed in a spaced apart relation to each other, each positioned near the opposite ends of the latch hook bracket 216. Each latch hook 220 may include handles or levers, enabling passengers to easily manipulate the latch hooks between the locked and unlocked conditions. This user-friendly design ensures that passengers can quickly and safely open the window in an emergency.

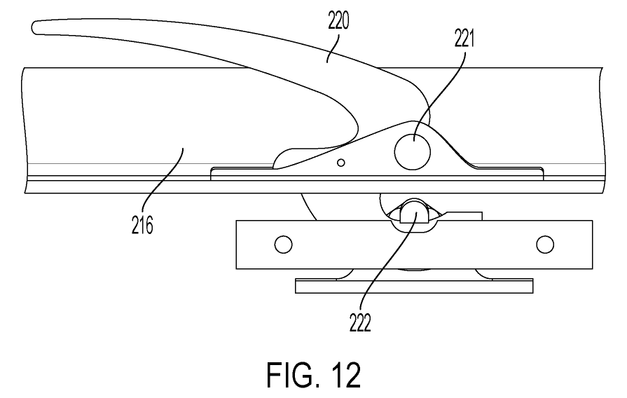

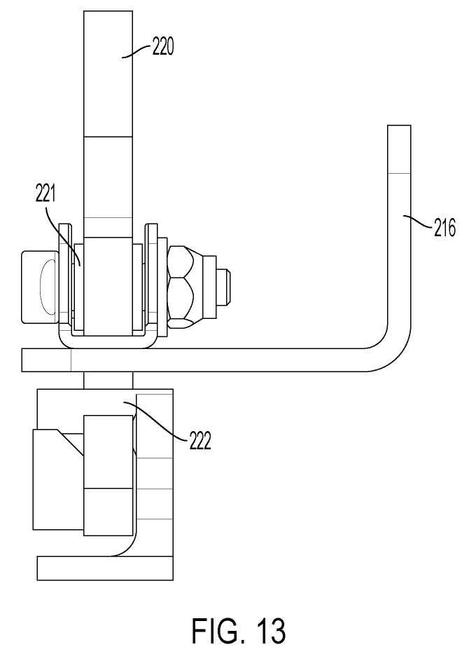

Mounted to an interior body sheet 108 adjacent to the bottom edge of the window aperture may be two latch pin brackets 218. Each latch pin bracket may include a latch pin 222, which, although hidden in FIG. 2, are depicted in more detail in FIGS. 12 and 13. In the locked condition, the latch pins 222 may be received within the latch hooks 220, securing the window 202 in place. This robust engagement between the latch hooks and latch pins maintains the window's integrity under normal conditions while allowing for rapid release in emergencies.

The opposing locations of the hinges 204 and the latch hooks 220 in the depicted configuration provide an effective mechanism for maintaining the window 202 in a firmly closed position under normal conditions. By situating the hinges 204 at the top edge of the window 202 and the latch hooks 220 at the bottom edge, the window 202 is securely anchored in place. This setup prevents inadvertent opening due to vibrations or external forces commonly encountered during vehicle operation. In the event of an emergency, the latch mechanism is designed for quick release, permitting the window 202 to pivot open swiftly and efficiently. This ensures rapid access to an emergency egress route, facilitating passenger evacuation without delay. The strategic positioning of these components thus balances the need for security and accessibility, enhancing the overall functionality of the emergency exit window assembly.

In addition to the depicted configuration, alternative locations for the latch hooks 220 and latch pin brackets 218 are possible. In alternative embodiments, the latch mechanism could be positioned along any one or more of the bottom, sides, and top edge of the window 202. Furthermore, in some embodiments, the latch hooks 220 could be mounted to the body of the vehicle, while the latch pin brackets 218 could be mounted to the window 202. Such alternative placements may be advantageous in certain vehicle designs or use cases, offering flexibility in accommodating different vehicle structures and passenger access needs. These alternative configurations provide versatility in design, ensuring that the emergency exit window assembly 200 can be tailored to suit a variety of vehicle types and operational requirements.

Furthermore, alternative locking mechanisms could be used for securing the emergency exit window assembly 200 in place of the latch mechanism, such as rotary locks, slide bolts, push button locks, hook and eye locks, and electronic locks. Rotary locks utilize a rotating cam or lever that, when turned, engages with a strike plate or locking bar to secure the window 202. This type of lock can provide a secure closure and can be easily operated with a simple twist motion. Slide bolts involve a manual sliding mechanism that moves a bolt into a corresponding receptacle or hole in the vehicle body or window frame. This simple yet effective mechanism can be used to lock the window securely in place. Push button locks include a button that, when pressed, releases a catch or bolt holding the window 202 closed. This type of lock is often easy to operate and can be designed for quick access in emergencies. Hook and eye locks involve a hook mechanism that latches onto a fixed eyelet or loop to secure the window 202. This type of lock is straightforward and reliable, providing a secure hold with easy manual operation. Electronic locks utilize an electronic mechanism, such as a solenoid or motor, to engage or disengage the lock. These can be activated by a switch or sensor and may offer additional security features, such as alarms or remote control. These alternatives can be tailored to fit the specific design and functional requirements of the emergency exit window, offering various levels of security, ease of use, and compatibility with different vehicle 100 types. Each mechanism has its own advantages and can be chosen based on the desired balance of security, accessibility, and simplicity.

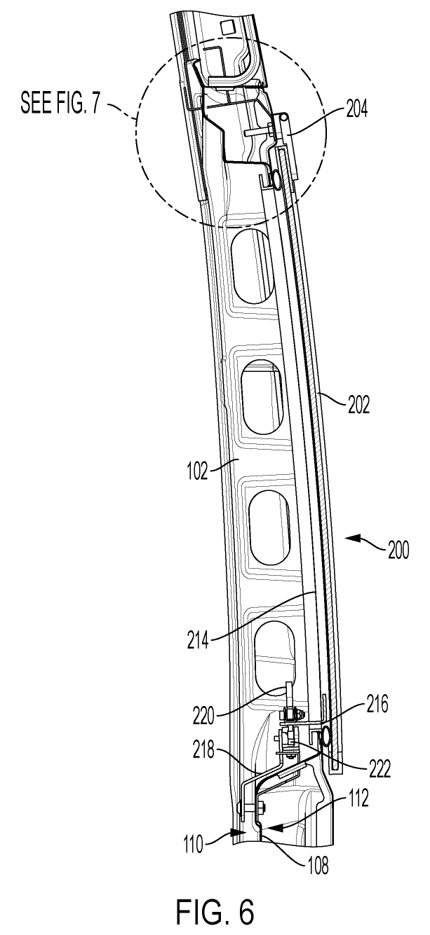

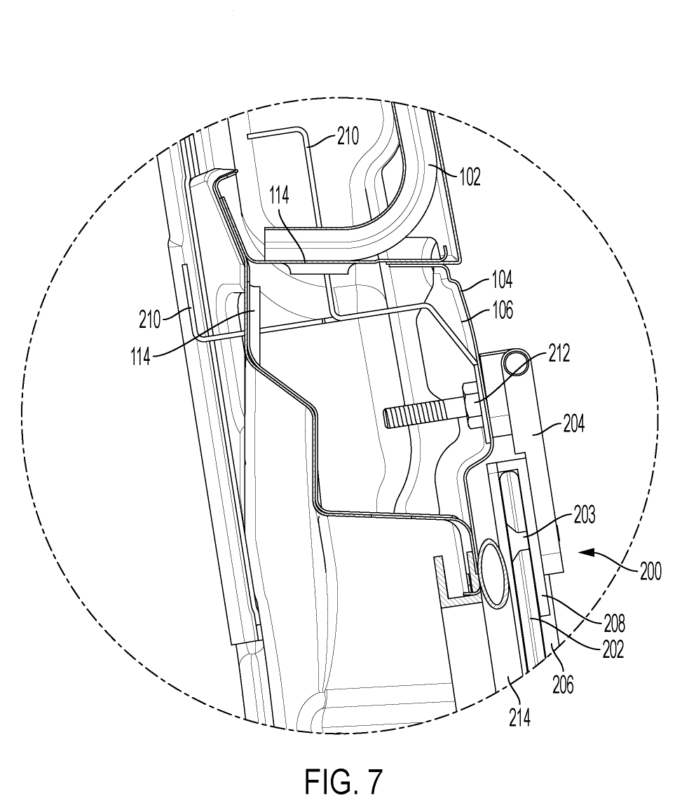

The body 102 of the vehicle 100 may be constructed from multiple body sheets that are meticulously formed and welded together to create a cohesive and robust structure. Visible from the interior of the vehicle 100 is an interior body sheet 108, which surrounds the window aperture and contributes to the overall structural integrity of the vehicle body 102. While the two latch pin brackets 218 and four hinges 204 may be directly fastened to the body 102, a stronger and more rigid attachment may result by using backing plates 210. In the depicted embodiment, two backing plates 210 abut the outer surface 112 of the interior body sheet 108 to serve as a mounting point for the two latch pin brackets 218, which abut the inner surface 110 of the body sheet 108. As seen more clearly in FIG. 6, fasteners extending through holes in the interior body sheet 108 interconnect the two backing plates 210 to the two latch pin brackets 218. Additionally, four backing plates 210 abut an inner surface 106 of an outer body sheet to serve as a mounting point for the four hinges 204, which abut the outer surface 104 of the outer body 102. As seen more clearly in FIGS. 6 and 7, fasteners extending through holes in the outer body 102 secure the four backing plates 210 with the four hinges 204.

A seal 214 may be mounted to or adjacent the perimeter of the window aperture. When the window 202 is in the closed position, the seal 214 engages with the inner surface 228 of the window 202, compressing to form a tight, weather-resistant barrier. This configuration prevents water, air, and other environmental elements from entering the vehicle 100, ensuring that the interior remains insulated and protected. The seal 214 also contributes to the overall soundproofing of the vehicle 100, reducing noise intrusion from the outside environment.

The interior configuration of the emergency exit window assembly 200 maintains the vehicle's aesthetics while ensuring compliance with safety standards. The design is adaptable to various vehicle 100 types, supporting the need for versatile and reliable emergency egress solutions.

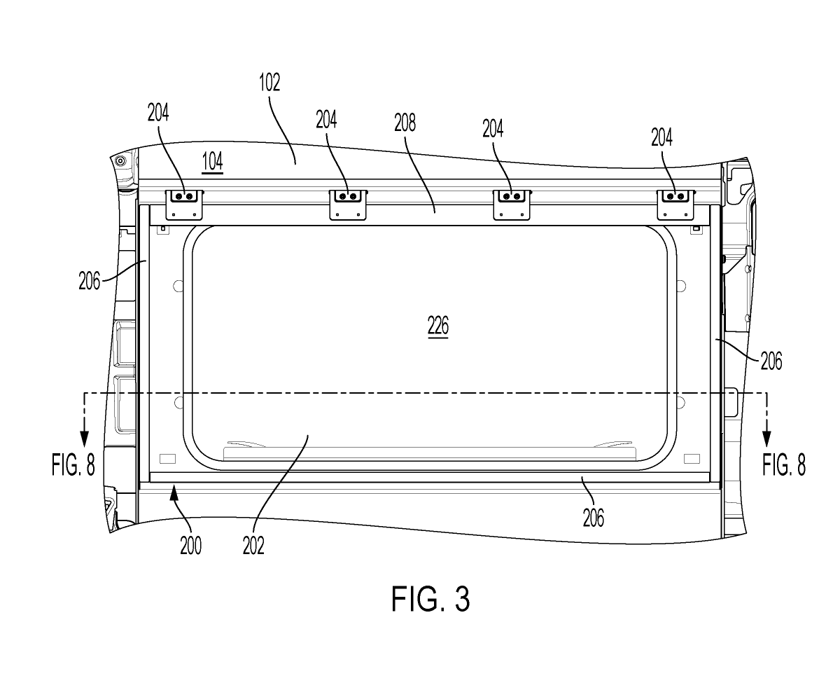

Referring to FIG. 3, a front view of the emergency exit window assembly 200 is shown in the closed position, as seen from the outside of the vehicle 100. This view highlights the external appearance of the window 202 when integrated into the vehicle body 102. The outer surface 226 of the window 202 may align with the outer surface 104 of the vehicle body, ensuring a smooth and aerodynamic profile. The frame members 206, 208, which provide structural support to the window 202, may be positioned along the edges, contributing to the seamless design. The hinges 204 are visible at the top edge of the window 202, facilitating the upward pivoting motion when the window 202 is opened. These hinges 204 are designed to blend with the vehicle 100 exterior while providing the necessary functionality for emergency egress.

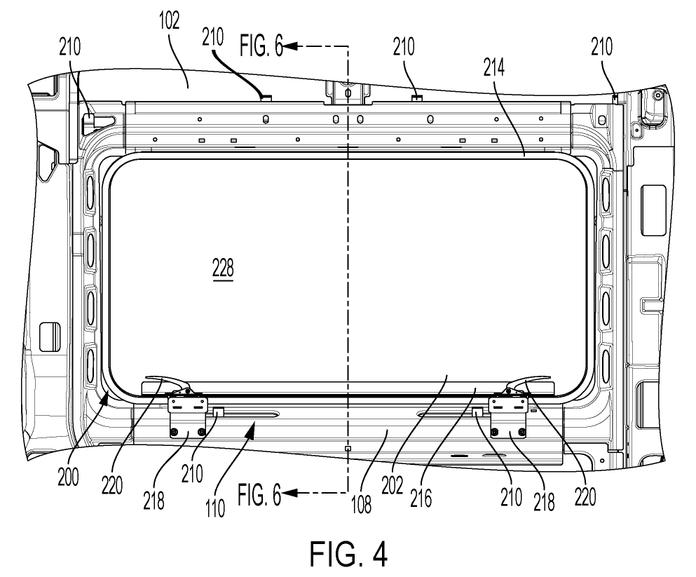

Turning to FIG. 4, a rear view of the emergency exit window assembly 200 is depicted in the closed position, as seen from inside the vehicle 100. This view provides insight into the interior components that secure the window 202 in place. The inner surface 228 of the window 202 faces the vehicle 100 interior, with the latch hook bracket 216, latch hooks 220, and latch pin brackets 218 prominently visible. These components, as part of the locking mechanism, ensure that the window 202 remains securely closed during normal operations. The latch pin brackets 218, which engage with the latch hooks 220, are mounted on the interior body sheet 108 adjacent to the bottom edge of the window aperture. The seal 214, running along the window 202 perimeter, interacts with the inner surface 228 to create a weather-resistant barrier, preventing external elements from entering the vehicle 100. Together, these features highlight the functionality and reliability of the emergency exit window assembly 200 in providing a secure and efficient egress route during emergencies.

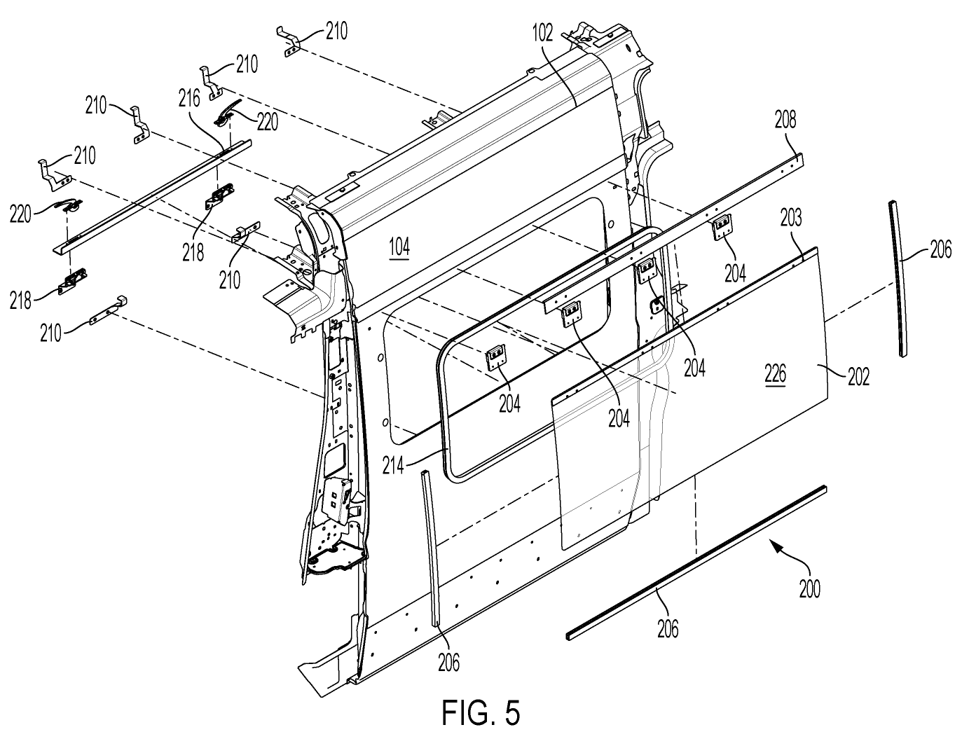

Referring to FIG. 5, an exploded view of the emergency exit window assembly 200 is presented, illustrating the various components and their assembly relationships. This view provides a comprehensive breakdown of the structural elements that comprise the window assembly 200, offering insight into how each part contributes to the overall functionality and integrity of the design.

At the core of the assembly is the window 202, which is made of a polycarbonate material providing shatter resistance and durability. Surrounding the window 202 are the frame members 206, 208, which are positioned along the edges to offer structural support and ensure a secure fit within the vehicle body 102. These frame members are designed to enhance the rigidity of the window assembly 200 while maintaining a low profile for aesthetic integration with the vehicle. While the window assembly 200 ideally utilizes the OEM-provided window 202 to save costs, embodiments that use a third-party provided window are contemplated.

The hinges 204 are shown at the top edge of the window 202, allowing for the pivotal motion necessary to open the window 202 for emergency egress. These hinges 204 are securely mounted to the outer surface 104 of the vehicle's outer body 102, ensuring stability and ease of operation. The latch hook bracket 216, along with the latch hooks 220, is depicted at the bottom edge of the window 202. This component provides the locking mechanism that holds the window 202 in the closed position under normal conditions.

Also visible are the latch pin brackets 218, which are mounted to the interior body sheet 108. These brackets 218 interact with the latch hooks 220 to secure the window 202 when closed. The backing plates 210, which reinforce the attachment points for both the hinges 204 and the latch pin brackets 218, are shown in their respective positions, providing additional strength and support to the assembly.

The seal 214 is illustrated running along the perimeter of the window 202, designed to engage with the window's inner surface 228 when closed. This seal 214 plays a role in preventing environmental elements from entering the vehicle 100, ensuring a weather-resistant closure. The exploded view in FIG. 5 offers a detailed understanding of the assembly process and the interaction of the components, highlighting the robust design of the emergency exit window assembly 200.

Referring to FIG. 6, a cross-sectional view of the emergency exit window assembly 200 along the vertical plane identified in FIG. 4 is depicted. This view provides detailed insight into the layered configuration of the window assembly 200 and its integration with the vehicle body 102. The window 202 is shown in cross-section, with the frame members 206, 208 providing reinforcement along its edges. These frame members 206, 208 are adhered to the window 202, contributing to the overall rigidity and stability of the window assembly 200.

The section also illustrates the interaction between the seal 214 and the inner surface 228 of the window 202. When the window 202 is in the closed position, the seal 214 compresses to form a tight, weather-resistant barrier, effectively preventing the ingress of water, air, and other environmental elements. This sealing action helps maintain the interior climate and acoustic comfort of the vehicle 100.

FIG. 6 further highlights the mounting arrangement of the latch pin brackets 218 and the backing plates 210. The latch pin brackets 218 may be secured to the interior body sheet 108, with backing plates 210 abutting the outer surface 112 of the interior body sheet 108. Fasteners extend through holes in the interior body sheet 108, interconnecting the backing plates 210 with the latch pin brackets 218, thereby reinforcing the locking mechanism.

Turning to FIG. 7, a detailed view is provided of how the hinges 204 are mounted to the body 102 of the vehicle 100. The hinges 204 may be secured to the outer surface 104 of the outer body 102, with backing plates 210 abutting the inner surface 106 of the outer body 102. Fasteners extend through holes in the outer body 102, securing the hinges 204 in place to the backing plates 210 and ensuring a stable pivoting action for the window 202.

Each hinge 204 may be fastened to the window 202 by one or more countersunk fasteners 224, which are inserted through holes in the window 202 from the inner surface 228 side. The through holes may be aligned via a fixture for ease and accuracy of assembly. These countersunk fasteners 224 provide a flush finish on the window's inner surface 228, maintaining a smooth aesthetic while ensuring the secure attachment of the hinges 204. Additionally, the countersunk fasteners 224 may disperse a clamping load when fastening the window 202 to the hinges 204. Other types of mechanical fasteners may introduce pin point forces that may result in a crack of the window 202 material. Other methods of securing the window 202 to the hinges 204 such as adhesives, welding to one of the frame members 206, 208, or any other method known in the art are contemplated herein. This configuration provides the necessary support for the window 202 to swing open in an emergency, facilitating rapid egress.

Also prominently shown in FIG. 7 is the cross section of frame member 208. The frame member 208 features an L-shaped cross-section. This design allows the frame member to abut the outer surface 226 of the window 202 effectively. The L-shape provides a single flange that extends along the edge of the window, ensuring a secure and stable connection while maintaining a low profile.

The locations on the outer surface 112 of the interior body sheet 108 and the inner surface 106 of the outer body 102 where the backing plates 210 must mount are not easily accessible. To address this challenge, the backing plates 210 are designed with handles or tabs that facilitate installation. These tabs are elongated and may include one or more bends as necessary to allow the mounting portion of the backing plate 210 to be properly positioned for securement to respective hinge 204 or latch pin bracket 218. The tabs extend through access holes 114 formed in the body 102, enabling the installer to maneuver the backing plates 210 into place without the need to insert fingers or hands into the access holes 114. This design ensures ease of installation and precise placement of the backing plates 210, enhancing the structural integrity of the assembly by securely anchoring the hinges 204 and latch pin brackets 218.

Together, FIGS. 6 and 7 illustrate the meticulous engineering and robust construction of the emergency exit window assembly 200, ensuring both operational reliability and compliance with safety standards.

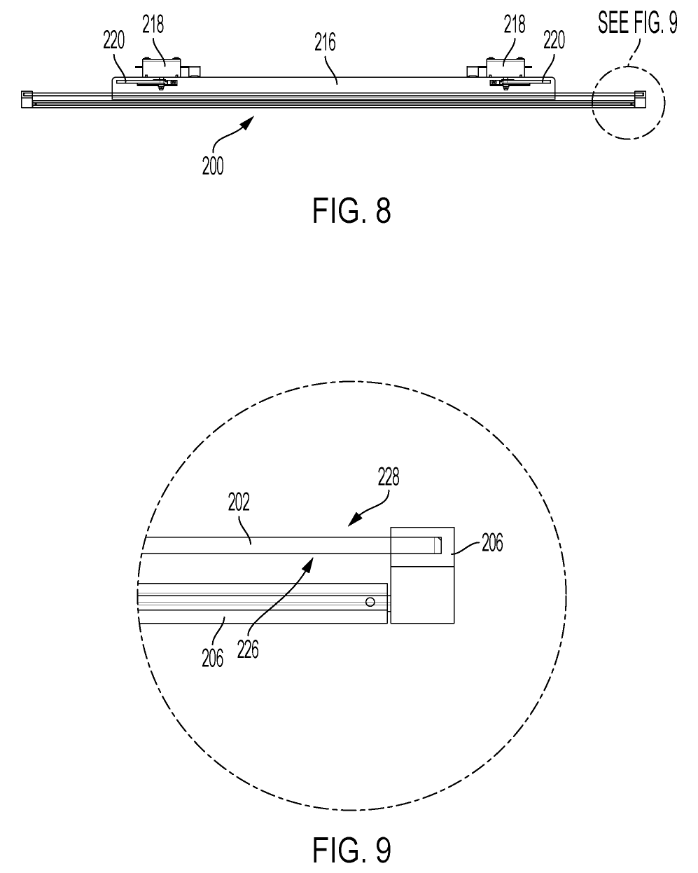

Referring to FIG. 8, a cross-sectional view of the emergency exit window assembly 200 along the horizontal plane identified in FIG. 3 is depicted. This view provides detailed insight into the lateral configuration of the window assembly 200. The window 202 is shown in cross-section, illustrating how the frame members 206 may be adhered along the window's lateral edges. These frame members 206 contribute to the window's 202 structural integrity, ensuring a secure fit within the vehicle body 102.

Turning to FIG. 9, a detailed view of an area identified in FIG. 8 is presented, focusing on the method by which a frame member 206 may be adhered to the window 202. An assembly fixture may be provided to align the frame members 206, 208 with the window 202 and hold the assembly in place while the adhesive cures to ensure proper alignment and a quality aesthetic finish. In this configuration, the frame member 206 may be designed with a U-shaped cross-sectional profile that allows it to snugly fit against the window 202 edge, abutting both the inner surface 228 and outer surface 226 of the window 202. High-strength adhesive may be utilized to bond the frame member 206 to the window 202, ensuring a durable connection that withstands the stresses encountered during vehicle operation.

The adhesive bond between the frame member 206 and the window 202 not only reinforces the window 202 edges but also contributes to the overall rigidity of the emergency exit window assembly 200. This configuration enhances the window assembly's 200 ability to maintain its integrity under various conditions, providing a reliable emergency egress solution. The detailed views in FIGS. 8 and 9 highlight the careful consideration given to the assembly's design, ensuring both functionality and durability while seamlessly integrating with the vehicle's design.

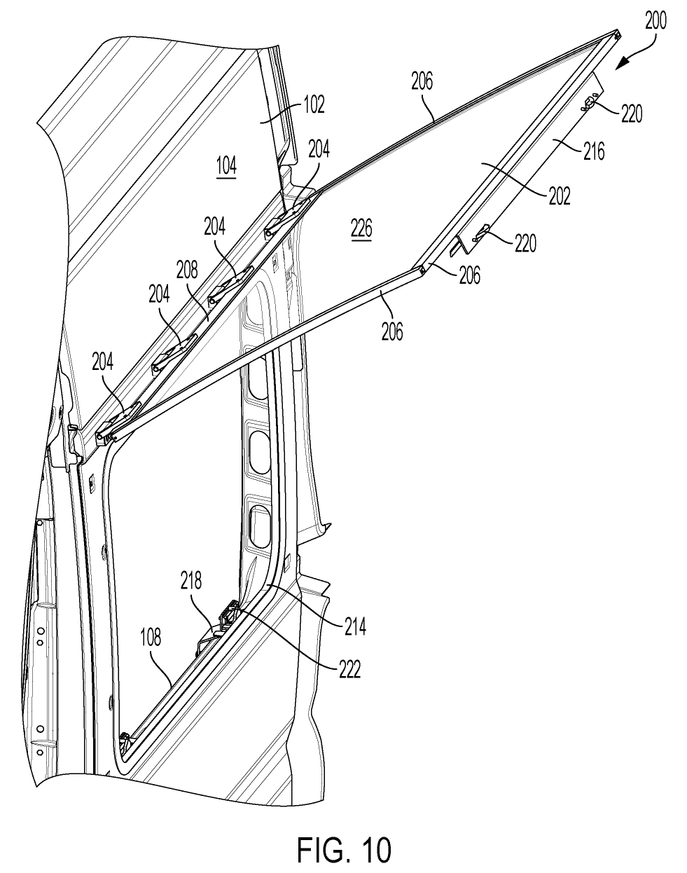

Referring to FIG. 10, a perspective view of the emergency exit window assembly 200 is shown in the open position, illustrating its function as an emergency egress route. This view highlights the pivotal action facilitated by the hinges 204, allowing the window 202 to swing outward from the vehicle body 102. The open position demonstrates the ample clearance provided for passengers to exit the vehicle 100 swiftly and safely in an emergency.

The hinges 204 are strategically positioned along the top edge of the window 202, enabling an upward swinging motion that maximizes the egress opening while maintaining stability. The latch mechanism, consisting of the latch hooks 220 and latch pin brackets 218, is disengaged in this position, illustrating the ease with which the window 202 can be opened from the inside.

The open configuration also provides a clear view of the frame members 206, 208, which remain securely attached to the window 202, providing structural support even when the window 202 is open. The seal 214, which engages with the inner surface 228 of the window when closed, is visible along the perimeter, ensuring that the window assembly 200 maintains its weather-resistant properties when returned to the closed position.

The design of the emergency exit window assembly 200, as shown in FIG. 10, emphasizes both functionality and user safety, offering a reliable means of egress that complies with safety standards while seamlessly integrating with the vehicle's aesthetics. This configuration ensures that the emergency exit window assembly 200 remains an unobtrusive yet essential safety feature.

It is further contemplated to add lift-assisting devices to the window assembly 200 such that the lift-assisting devices helps move the window 202 to the open position, easing the effort required during the emergency scenario. The lift-assisting devices may include a torsion spring, gas spring, or any other well-known device in the art.

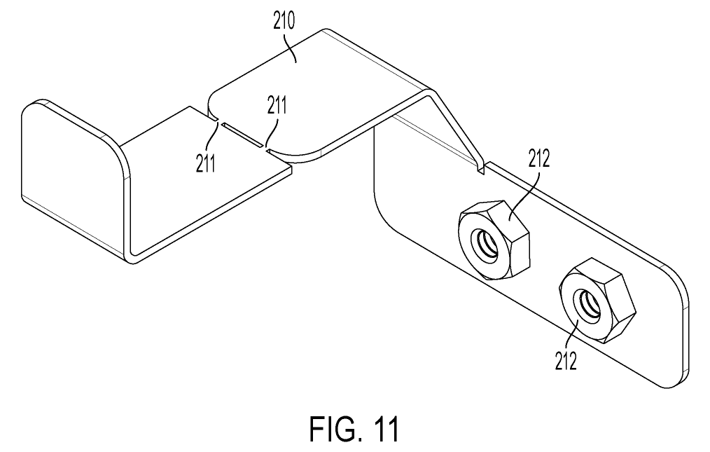

Referring to FIG. 11, a perspective view of one of the backing plates 210 is depicted, showcasing its design and functional characteristics. The backing plate 210 provides reinforcement and support for the attachment points of the hinges 204 and latch components, helping the overall assembly to comply with the relevant regulations.

The backing plate 210 may be designed with a robust structure to withstand the forces exerted during an ejection scenario. It features a mounting portion that aligns with and reinforces the corresponding body sheet, allowing for secure attachment via fasteners. Fixed to the backing plate 210 are fasteners 212, which may be weld nuts or rivet nuts designed to facilitate the connection to the hinges 204 or latch pin brackets 218 with bolts or screws. These fixed-in-place fasteners ensure a secure and reliable attachment, enhancing the overall stability of the window assembly 200.

In addition to its primary function of reinforcement, the backing plate 210 may be equipped with handles or tabs to aid in installation. These tabs are designed to extend through access holes 114 in the vehicle body 102, enabling precise positioning without the need for inserting fingers or hands into confined spaces. This feature not only simplifies the installation process but also ensures that the backing plate 210 is accurately aligned with the necessary components. The backing plate 210 also includes frangible connectors 211, which define a breakable connection between at least a portion of the elongated tabs and the main body of the backing plate 210. These tabs are designed to break away once the backing plate is securely installed so that the backing plates 210 are substantially contained within the access holes 214 after installation. This helps maintain the aesthetic of the vehicle 100 by not having the backing plates 210 stick out after installation.

The design and construction of the backing plate 210, as illustrated in FIG. 11, underscore its importance in maintaining the structural integrity and reliability of the emergency exit window assembly 200. By providing a stable foundation for key components, the backing plate 210 ensures the durability and functionality of the window assembly 200 under various conditions.

Referring to FIGS. 12 and 13, the latch mechanism of the emergency exit window assembly 200 is depicted in detail, illustrating its components and operation. FIG. 12 presents a rear view of the latch mechanism, while FIG. 13 provides a side view, together offering a comprehensive understanding of the locking system that secures the window 202 in the closed position.

The latch mechanism comprises latch hooks 220 and latch pin brackets 218, which interact to lock the window securely. In FIG. 12, the latch hooks 220 are shown mounted to the latch hook bracket 216, which is secured to the inner surface 228 of the window 202. These hooks 220 are designed to engage with latch pins 222, housed within the latch pin brackets 218, securing the window 202 when closed. The latch hooks 220 include handles or levers, enabling passengers to easily manipulate them between the locked and unlocked conditions, facilitating swift operation during an emergency.

FIG. 13 provides a side view of the latch mechanism, highlighting the spatial relationship between the latch hooks 220 and the latch pins 222. The latch pins 222, which are part of the latch pin brackets 218 mounted to the interior body sheet 108, serve as the anchor points for the latch hooks 220. When in the locked condition, the latch pins 222 are received within the latch hooks 220, ensuring a secure seal and preventing inadvertent opening during vehicle operation.

The configuration of the latch mechanism, as shown in FIGS. 12 and 13, emphasizes its reliability and ease of use. The design allows for quick disengagement in emergencies, permitting the window 202 to open rapidly and provide an unobstructed egress route. This functionality ensures passenger safety and compliance with relevant safety standards, making the latch mechanism an integral component of the emergency exit window assembly 200.

In one embodiment, the conversion of an OEM window assembly into the emergency exit window assembly 200 of the present embodiment begins with the removal of the OEM window from the vehicle. Originally, the OEM window assembly is installed on the vehicle 100 by the manufacturer, typically secured within the vehicle body 102 using adhesives and/or mechanical fasteners. The OEM window is designed to provide a durable and weather-tight seal, ensuring protection against environmental elements while maintaining the vehicle 100 aesthetic and aerodynamic properties.

To initiate the conversion process, the OEM window must first be carefully removed from the vehicle 100. This involves the use of specialized tools to safely detach the window without causing damage to the surrounding vehicle body 102 or the window itself. The removal process typically begins by cutting through the adhesive bond that secures the window to the body 102, employing a reciprocating saw or a similar cutting tool equipped with a blade designed for windshield or window removal. During this process, a lubricant or cooling agent such as water may be applied to the cutting tool to prevent overheating and ensure a clean cut.

Once the adhesive bond is severed, any additional mechanical fasteners or mounting hardware securing the window, such as clips or brackets, are carefully disengaged. This step requires precision to avoid damaging the window or the vehicle body 102. With all securing elements removed, the OEM window can be gently extracted from the aperture in the vehicle body. Care is taken to protect the vehicle's paint and bodywork during removal, as well as to preserve the integrity of the OEM window for potential reuse or recycling.

The successful removal of the OEM window assembly sets the stage for the installation of the emergency exit window assembly 200, transforming the vehicle 100 to enhance passenger safety through the provision of an accessible egress route in emergencies.

Following the removal of the OEM window, the next steps in converting to the emergency exit window assembly 200 involve installing key components onto the window 202, including the frame members 206, 208, hinges 204, and latch hook bracket 216. These components transform the window 202 into a functional emergency exit.

The installation process may begin with the attachment of the frame member 208, which features an L-shaped cross-section and is positioned along the top edge of the window 202. This frame member 208 abuts only the outer surface 226 of the window 202 and is secured in place using high-strength adhesive. Its installation serves as a foundation for mounting the hinges 204.

Once the frame member 208 is securely in place, the hinges 204 may be attached. As illustrated in FIGS. 3 and 7, the hinges 204 are designed to facilitate the upward pivoting motion of the window 202, allowing it to swing open in emergencies. The hinges 204 are secured to the outer surface 226 of the window 202, over the frame member 208, using countersunk fasteners 224, which are inserted through pre-drilled holes from the inner surface 228 side. This method ensures a flush finish, maintaining the window's smooth aesthetic while providing robust support for the pivoting action.

Next, the latch hook bracket 216 may be installed along the bottom edge of the window 202, as detailed in FIG. 5. The latch hook bracket 216 may be an elongated, generally L-shaped structure that extends nearly the entire width of the window 202. It is secured to the inner surface 228 of the window 202, providing a mounting point for the latch hooks 220. These hooks 220 engage with the latch pins 222 in the latch pin brackets 218 to secure the window 202 in the closed position, as depicted in FIGS. 12 and 13. The precise installation of the latch hook bracket 216 ensures the reliable operation of the locking mechanism, facilitating quick and easy release during emergencies.

Finally, the frame members 206 are adhered along the lateral and bottom edges of the window 202, as shown in FIGS. 8 and 9. These frame members 206 may be designed with a U-shaped cross-sectional profile, allowing them to snugly fit against the window 202 edges, abutting both the inner surface 228 and outer surface 226. High-strength adhesive is employed to bond these frame members 206 to the window 202, reinforcing its structural integrity and ensuring a secure fit within the vehicle body 102. This configuration enhances the window's ability to withstand operational stresses and maintain its position under normal and emergency conditions.

The installation of these components transforms the window 202 into a functional emergency exit, ready to be integrated into the vehicle body 102 for enhanced passenger safety and compliance with safety standards.

With the emergency exit window assembly 200 prepared, the next steps involve mounting the latch pin brackets 218 and hinges 204 to the vehicle body 102, followed by the installation of the seal 214. These steps ensure the stability and functionality of the emergency exit window assembly 200.

The installation process begins with the mounting of the latch pin brackets 218. These brackets are positioned adjacent to the bottom edge of the window aperture on the interior body sheet 108. As illustrated in FIG. 6, the latch pin brackets 218 are secured using fasteners that pass through pre-drilled holes in the interior body sheet 108 and the backing plates 210 that abut the outer surface 112 of body sheet 108. This configuration ensures a robust and stable attachment, providing reliable anchor points for the latch hooks 220 to engage with the latch pins 222 when the window 202 is in the closed position. The precise alignment of the latch pin brackets 218 ensures the proper operation of the locking mechanism, facilitating secure closure and rapid release during emergencies. Assembly fixtures may be utilized to align the window assembly 200 and latch pin brackets 218 in their final assembly position to mark the holes to be drilled for receiving the fasteners. The window assembly 200 and the latch pin brackets 218 may be removed for drilling the holes, or they may remain in place while the holes are drilled in the body 102 and body sheet 108.

Next, the hinges 204 are mounted to the outer surface 104 of the vehicle body 102, as depicted in FIG. 7. These hinges 204 are aligned with the previously installed frame member 208 at the top edge of the window aperture. Backing plates 210 abut the inner surface 106 of the outer body 102, and fasteners extend through pre-drilled holes to secure the hinges 204 in place. This assembly provides the necessary support for the window's pivoting motion, allowing it to swing open effectively in an emergency. Other methods of securing the hinges 204 to the outer surface 104 of the vehicle body 102 such as adhesives, welding, or any other process known in the art are contemplated herein.

Finally, the seal 214 is installed along the perimeter of the window aperture. This seal engages with the inner surface 228 of the window 202 when it is closed, compressing to form a tight, weather-resistant barrier. The seal 214 is designed to prevent the ingress of water, air, and other environmental elements, ensuring that the vehicle 100 interior remains insulated and protected. Additionally, the seal 214 contributes to the overall soundproofing of the vehicle 100, reducing noise intrusion from the external environment.

The installation of the latch pin brackets 218, hinges 204, and seal 214 completes the integration of the emergency exit window assembly 200 into the vehicle 100, ensuring enhanced passenger safety and compliance with safety standards through a reliable and accessible egress solution.

It is important to note that the installation steps described for converting the OEM window into the emergency exit window assembly 200 are illustrative and may be performed in any order that is practical for the installer. The sequence of steps can be adjusted to accommodate specific vehicle configurations, installer preferences, or other logistical considerations. Additionally, the use of alternative installation methods and tools is contemplated and encouraged to enhance efficiency, safety, or effectiveness.

For instance, while high-strength adhesive is recommended for securing frame members, mechanical fasteners may also be employed where appropriate. Similarly, while the described method involves specific tools for removing the OEM window, alternative cutting or detachment techniques may be utilized based on the available equipment or installer expertise.

Ultimately, the goal is to ensure a secure, reliable, and compliant installation of the emergency exit window assembly 200, providing enhanced safety and accessibility for vehicle 100 occupants. Installers are encouraged to adapt the process to best fit their unique circumstances while adhering to the fundamental principles of sound engineering and safety standards.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method for converting a vehicle to include an emergency exit assembly, the method comprising:
providing a vehicle having a panel covering an aperture in a body of the vehicle;
decoupling the panel from the body;
coupling at least one hinge between the panel and the body whereby the panel can pivot about the at least one hinge from a closed position, in which the panel covers the aperture, to an open position whereby a passenger can exit the vehicle through the aperture; and
coupling at least one locking mechanism between the panel and the body, whereby the locking mechanism in a locked configuration locks the panel in the closed position.

2. The method of claim 1, further comprising coupling at least one frame member to the panel at or substantially adjacent a perimeter of the panel.

3. The method of claim 2, wherein the at least one frame member comprises a frame member having a generally U-shape cross-section that receives the perimeter of the panel.

4. The method of claim 2, wherein the at least one frame member comprises a frame member having a generally L-shape cross-section that receives the perimeter of the panel.

5. The method of claim 2, wherein the at least one frame member is adhered to the panel.

6. The method of claim 1, wherein the step of coupling the at least one hinge comprises fastening the at least one hinge to a backing plate, wherein the hinge is disposed at one side of a body sheet and the backing plate is disposed at an opposite side of the body sheet.

7. The method of claim 6, wherein the backing plate comprises an integrated fastener.

8. The method of claim 6, wherein the backing plate comprises a tab frangibly connected to a main body of the backing plate.

9. The method of claim 6, wherein the backing plate is disposed at an internal surface of the body.

10. The method of claim 9, wherein the at least one hinge is disposed at an external surface of the body.

11. The method of claim 1, wherein the at least one locking mechanism comprises a latch hook configured to lockingly engage a latch pin, and the step of coupling the at least one locking mechanism comprises fastening the latch pin to a backing plate, wherein the latch pin is disposed at one side of a body sheet and the backing plate is disposed at an opposite side of the body sheet.

12. The method of claim 11, wherein the backing plate comprises an integrated fastener.

13. The method of claim 11, wherein the latch hook is coupled to the panel and the latch pin is coupled to the body.

14. The method of claim 11, wherein the backing plate comprises a tab frangibly connected to a main body of the backing plate.

15. The method of claim 1, wherein the at least one locking mechanism can be moved from the locked configuration to an unlocked configuration by hand.

16. The method of claim 1, further comprising affixing a seal between the panel and the body when the panel is in the closed position.

17. The method of claim 1, wherein the emergency exit assembly complies with 49 CFR § 571.217.

18. The method of claim 1, wherein the emergency exit assembly complies with 49 CFR § 571.226.

19. A modified vehicle comprising:
a body with an aperture, wherein:
in an original equipment manufacturer condition, a panel covers the aperture; and
in a modified condition, an emergency exit assembly covers the aperture, wherein the emergency exit assembly comprises:
the panel;
at least one hinge coupled between the panel and the body, whereby the panel can pivot about the at least one hinge from a closed position, in which the panel covers the aperture, to an open position whereby a passenger can exit the vehicle through the aperture; and
at least one locking mechanism coupled between the panel and the body, whereby the locking mechanism in a locked configuration locks the panel in the closed position.

20. A kit for converting a panel covering an aperture in a body of a vehicle into an emergency exit assembly, the kit comprising:
at least one hinge configured to be coupled between the panel and the body, whereby the panel can pivot about the at least one hinge from a closed position, in which the panel covers the aperture, to an open position whereby a passenger can exit the vehicle through the aperture; and
at least one locking mechanism configured to be coupled between the panel and the body, whereby the locking mechanism in a locked configuration locks the panel in the closed position;
wherein the kit omits the panel.
